(19) United States
(12) Patent Application Publication
(10) Pub. No.: US 2025/0102080 A1
(43) Pub. Date: Mar. 27, 2025

(54) CONDUIT SUPPORT ASSEMBLY

(71) Applicant: PTW Products Inc., Garden Grove, CA (US)

(72) Inventor: Charles E. Jacot, Garden Grove, CA (US)

(73) Assignee: PTW Products Inc., Garden Grove, CA (US)

(21) Appl. No.: 18/888,302

(22) Filed: Sep. 18, 2024

Related U.S. Application Data
(60) Provisional application No. 63/539,850, filed on Sep. 22, 2023.

(51) Int. Cl. F16L 3/02; F16L 3/26

(52) U.S. Cl. CPC F16L 3/02; F16L 3/26

(57) ABSTRACT

A conduit support assembly includes a clip operatively connected to a base. The clip comprises a support, an extension, and a flange. The support has a support surface and a bottom, the extension extends downward from the bottom, and the flange extends outward from the extension. The clip is configured and arranged to support one of a cradle or a conduit and, if used, the cradle is configured and arranged to support a conduit. Optionally, a UV protectant may be applied to the conduit.

### CROSS-REFERENCE TO RELATED APPLICATIONS

This application claims the benefit of U.S. Provisional Patent Application Ser. No. 63/539,850, filed Sep. 22, 2023, entitled CONDENSATE DRAIN LINE ASSEMBLY, which is incorporated herein by reference in its entirety.

### BACKGROUND

Many types of buildings have exterior equipment and/or appliances that generate waste that is directed away from the buildings and, in some cases, to approved AHJ waste receptors. Waste drainage conduits are commonly used to route the waste from the equipment and/or appliance to the desired area. Exterior drainage conduits are commonly made of copper or PVC. Copper piping is a relatively expensive material, which is also expensive to install, and there is a risk of theft for copper piping. PVC piping tends to warp and/or degrade from sun exposure.

Example exterior equipment and/or appliances include air conditioning units and heat pumps positioned on building rooftops, which generate condensation created by air conditioner evaporator coils and heat pumps, and the condensation is preferably routed off the roof. Condensate drain conduits are commonly used to route condensation from the air conditioning units and heat pumps, along the roof, and to a gutter or a drain.

Buildings may also have electrical wires, gas lines, and other types of connections that can be routed through conduits for protection from elements, pests, etc.

For the reasons stated above and for other reasons stated below, which will become apparent to those skilled in the art upon reading and understanding the present specification, there is a need in the art for an improved conduit support assembly to direct waste away from buildings.

### SUMMARY

The above-mentioned problems associated with prior devices are addressed by embodiments of the disclosure and will be understood by reading and understanding the present specification. The following summary is made by way of example and not by way of limitation. It is merely provided to aid in understanding some of the aspects of the invention.

In one embodiment, a clip for use with a conduit support assembly comprises a support, an extension, and a flange. The support has a support surface and a bottom, the extension extends downward from the bottom, and the flange extends outward from the extension.

In one embodiment, a conduit support assembly comprises a base, a clip, and a cradle. The clip is configured and arranged to be operatively connected to the base, and the cradle is operatively connected to the clip. The cradle is configured and arranged to receive a conduit.

In one embodiment, a conduit support assembly comprises a base, a clip, a cradle, and a conduit. The clip is configured and arranged to operatively connect to the base and includes a support. The cradle is supported by the support, and the conduit is supported by the cradle.

In one embodiment, a method of installing a conduit support assembly comprises positioning a base on a surface, connecting a clip to the base, connecting a cradle to the clip, and positioning a conduit on the cradle. In some embodiments, the base includes a plurality of bases positioned up to 10 feet apart. In some embodiments, the cradle includes gaps to accommodate joints in the conduit. In some embodiments, a UV protectant is applied to the conduit.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. In accordance with common practice, the various described features are not drawn to scale but are drawn to emphasize specific features relevant to the present disclosure. Reference characters denote like elements throughout the Figures and the text.

FIG. 1 is a top perspective view of an embodiment conduit support assembly constructed in accordance with the principles of the present invention;

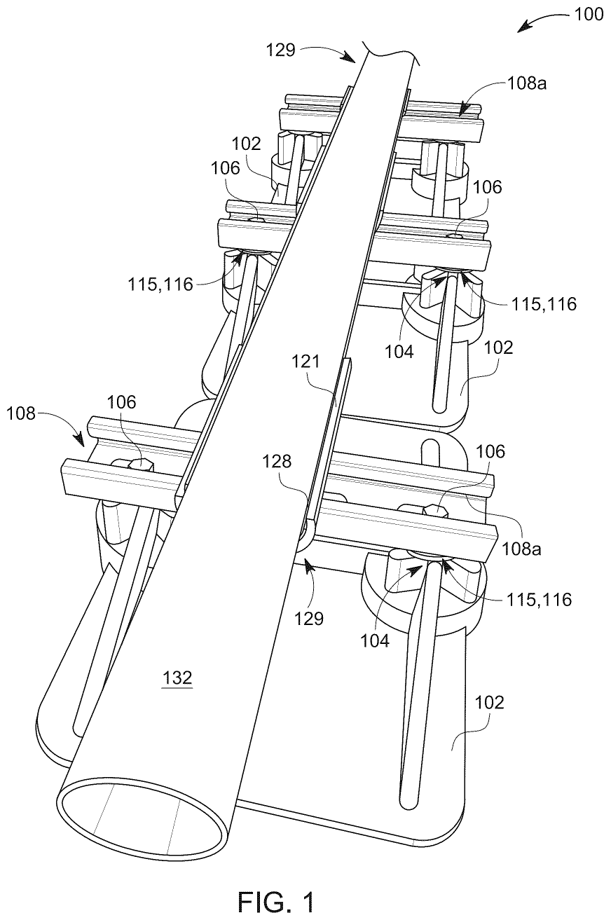

FIG. 2 is a top perspective view of a base of the conduit support assembly shown in FIG. 1;

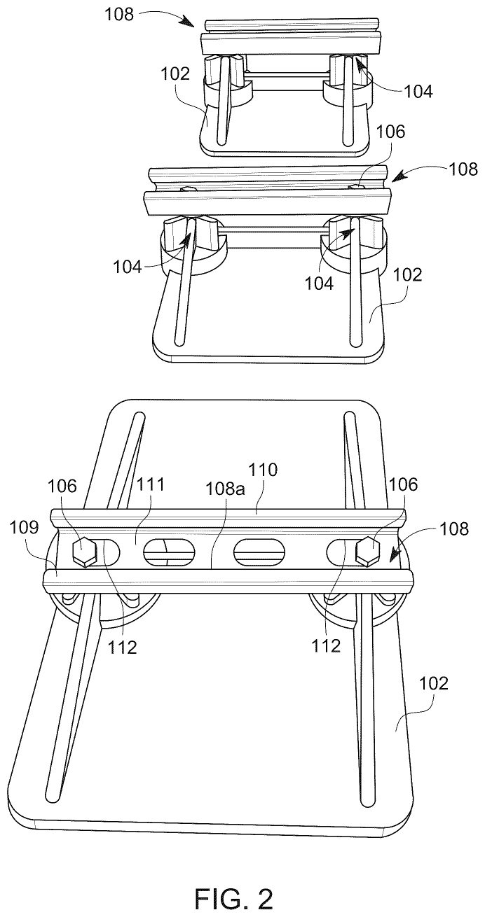

FIG. 3 is a top perspective view of a clip of the conduit support assembly shown in FIG. 1;

FIG. 4 is a top perspective view of the clip shown in FIG. 3 operatively connected to the base shown in FIG. 2 of the conduit support assembly shown in FIG. 1; and

FIG. 5 is a top perspective view of a cradle operatively connected to the clip and the base shown in FIG. 4 of the conduit support assembly shown in FIG. 1.

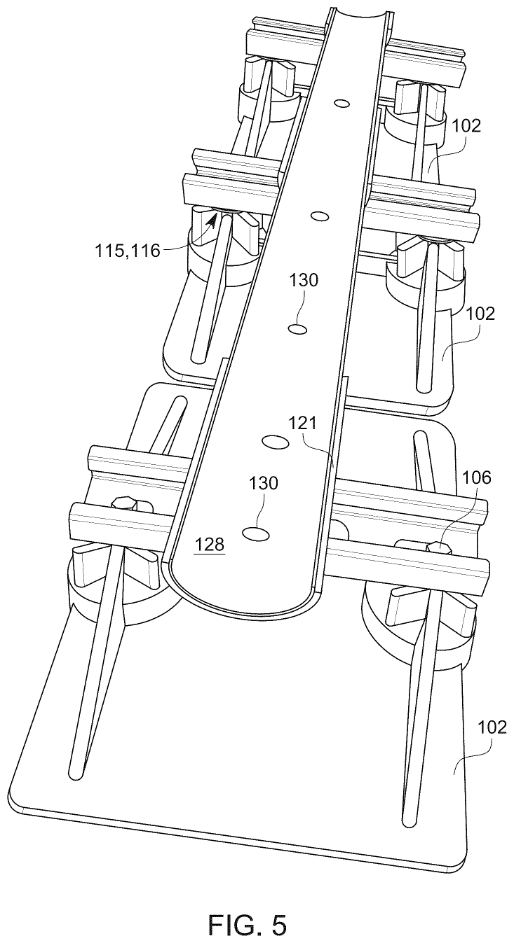

### DETAILED DESCRIPTION

In the following detailed description, reference is made to the accompanying drawings, which form a part hereof, and in which is shown by way of illustration embodiments in which the disclosure may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that other embodiments may be utilized and mechanical changes may be made without departing from the spirit and scope of the present disclosure. The following detailed description is, therefore, not to be taken in a limiting sense.

Embodiments of the disclosure generally provide a conduit support assembly. The term conduit includes various types of channels, piping, tubing and the like that transport waste such as water, condensation, or other fluid waste or through which electrical wires, gas lines, and other types of connections are routed and, therefore, these terms can be used interchangeably. Generally, a clip configured and arranged to support a cradle is operatively connected to a base. The cradle is configured and arranged to support a conduit. There may be gaps in the cradle to accommodate joints or expansion joints in the conduit, if used. Optionally, a UV protectant may be applied to the conduit.

An example of a suitable base 102 is shown and described in U.S. Pat. No. 6,592,093, which is incorporated by reference in its entirety herein. It is recognized that any suitable base could be used. In this example base 102, tubular sleeves 104 extend upward from opposing sides of the base 102 and are configured and arranged to receive threaded rods 106. A channel 108 (e.g. UNISTRUT™ channel) is formed by a first top portion 109 and a second top portion 110, which form an opening 108a, and a bottom 111 interconnected with sides. The bottom 111 includes apertures 112 through which the threaded rods 106 extend, and the height of the channel 108 relative to the base 102 can be adjusted using locking nuts 115 and washers 116. The use of locking nuts and washers to adjust the height relative to the base along the threaded rods is known in the art. Varying the heights of the channels 108 along the length of the system can facilitate a pitch for draining via gravity. Preferably, the base 102 has a weight of at least two pounds. Optionally, regardless of the weight of the base 102, a suitable adhesive can be used to secure the bottom of the base 102 to the support surface, for example a rooftop. The bases 102 can be positioned at desired intervals, for example preferably up to 10 feet apart. The spacing between the bases 102 in the figures does not illustrate the preferred spacing. It is recognized that system design and installation can vary depending upon the site layout and the type of equipment used with the conduit support assembly.

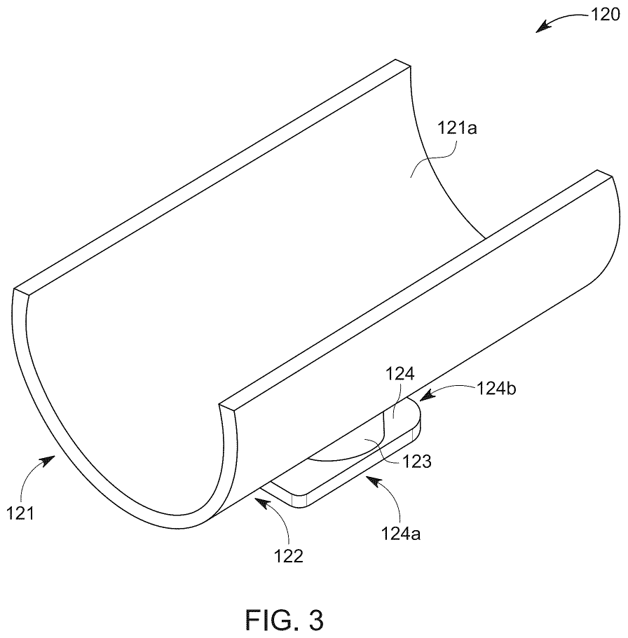

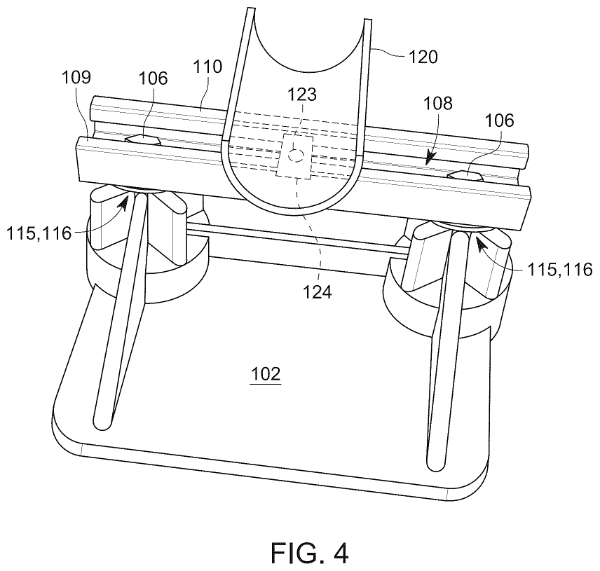

An example clip 120 is shown in FIG. 3. The clip 120 includes a U-shaped support 121 with a support surface 121a configured and arranged to receive and support the cradle 128 or, if the cradle 128 is not used, the conduit 132. Preferably, the support 121 is configured and arranged to frictionally engage the cradle or the conduit. The cradle or the conduit could snap into the support 121. The sides of the support 121 could deflect as the cradle or the support is positioned within the support 121 on the support surface 121a. Thus, the cradle or the support is preferably selectively, releasably secured within the support. An extension 123 extends downward from a bottom 122 of the support 121, and a flange 124 extends outward longitudinally from opposing sides of the extension 123. The flange 124 includes a length 124a and a width 124b. The length 124a is larger than the width 124b and the opening 108a of the channel 108, and the width 124b is smaller than the opening 108a of the channel 108. The flange 124 is inserted into the channel 108, with the length 124a aligned with the opening 108a, and then the clip 120 is rotated approximately 90 degrees so that the flange 124 is captured between the bottom 111 and the first and second top portions 109, 110 of the channel 108 and the clip 120 extends perpendicular relative to the channel 108. The extension 123 extends between the first and second top portions 109, 110 and the support 121 is positioned above the channel 108. This is illustrated in broken lines in FIG. 4. Preferably, the clip 120 is made of a material capable of withstanding sun exposure, for example materials that will not melt up to 300° F. and that will not easily degrade. Although clip 120 is designed to operatively connect to the example base 102 with the example channel 108, it is recognized that other suitable clips for connecting to other types of suitable bases could be used.

The clip's support 121 is configured and arranged to receive and preferably frictionally engage the cradle 128. Although in this embodiment the support 121 and the cradle 128 are separate components, it is recognized that they could be a single component. The support 121 could be configured and arranged so that a separate cradle is not needed or the cradle could be integral with the support. The cradle 128 is preferably U-shaped to support conduits, which are preferably ½ inch or larger in diameter. The cradle 128 extends between bases 102 and can include cradle segments to create gaps 129 configured and arranged to accommodate joints (not shown) in the conduits. When using a conduit made of PVC, and when required by code, it is recommended to install expansion joints (not shown) that fit between cradle segments. Although any suitable length could be used, the cradle 128 is preferably up to 10 feet long and is made of a non-corrosive metallic material. Additional bases 102 may be needed where branch lines are installed. Optionally, the bottom of the cradle 128 can include weep holes 130 for moisture drainage between the cradle 128 and the conduit 132.

The conduit 132 allows for waste or wires/lines to be routed from the equipment or appliance to a desired location such as a drain, a waste receptable, an outlet, and the like. A drain could be a gutter or a conventional drain. The conduit 132 can be made of any suitable material. An example of a suitable material is PVC. Optionally, the PVC conduit can be coated with a UV protectant so that it is resistant to degradation from sun exposure. Although metal such as copper could also be used for the conduit, given the costs associated with copper and the risk of theft, copper may be less desirable.

Advantages include that the assembly allows for up to 10 feet of spacing instead of 32 inches spacing, which saves money on fewer supports and less labor for installation. If a conduit made of PVC or a similar material is used, the installation and material costs are less than that of copper piping. In addition, without copper, the risk of theft is eliminated.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A clip for use with a conduit support assembly, comprising:
a support having a support surface and a bottom;
an extension extending downward from the bottom; and
a flange extending outward from the extension.

2. The conduit support assembly of claim 1, wherein the support is U-shaped and is configured and arranged to frictionally engage one of a cradle or a conduit.

3. The conduit support assembly of claim 1, wherein the flange extends outward longitudinally from opposing sides of the extension.

4. The conduit support assembly of claim 1, wherein the flange has a length and a width, the length being larger than the width.

5. The conduit support assembly of claim 4, wherein the width is configured and arranged to be inserted into a channel, the length being larger than the channel.

6. The conduit support assembly of claim 1, further comprising a cradle configured and arranged to be frictionally engaged by the support, the cradle configured and arranged to support a conduit.

7. The conduit support assembly of claim 1, further comprising a base including a channel, the flange configured and arranged to be positioned within the channel, the extension configured and arranged to extend through the channel, and the support configured and arranged to be positioned above the channel.

8. A conduit support assembly, comprising:
a base;
a clip configured and arranged to operatively connect to the base; and
a cradle operatively connected to the clip, the cradle configured and arranged to receive a conduit.

9. The conduit support assembly of claim 8, wherein the base includes a channel configured and arranged to receive a flange of the clip, the flange having a length and a width, the length being larger than the width and an opening of the channel, the width being smaller than the opening of the channel.

10. The conduit support assembly of claim 9, wherein the channel extends perpendicular relative to the clip and the cradle.

11. The conduit support assembly of claim 8, wherein the clip includes a support configured and arranged to support the cradle.

12. The conduit support assembly of claim 8, wherein the clip frictionally engages the cradle.

13. The conduit support assembly of claim 8, wherein the clip and the cradle are separate components.

14. The conduit support assembly of claim 8, wherein the cradle is made of a non-corrosive metallic material.

15. A conduit support assembly, comprising:
a base;
a clip configured and arranged to operatively connect to the base, the clip including a support;
a cradle supported by the support; and
a conduit supported by the cradle.

16. The conduit support assembly of claim 15, wherein the clip includes a support configured and arranged to support the cradle.

17. The conduit support assembly of claim 15, wherein the clip and the cradle are separate components.

18. The conduit support assembly of claim 15, wherein the clip and the cradle are a single component.

19. The conduit support assembly of claim 15, wherein the cradle is made of a non-corrosive metallic material.

20. The conduit support assembly of claim 15, wherein the conduit is made of PVC coated with a UV protectant.
